(19) United States
(12) Patent Application Publication
(10) Pub. No.: US 2009/0230944 A1
(43) Pub. Date: Sep. 17, 2009

(54) ELECTRONIC DEVICE

(76) Inventors: Michiyuki Kitamoto, Yokohama-shi (JP); Kiyoshi Senoue, Yokohama-shi (JP); Hidenori Suzuki, Yokohama-shi (JP); Yukinori Akamoto, Imba-gun (JP); Kenichi Takahashi, Yokohama-shi (JP); Yoshie Ozeki, Saitama-shi (JP); Takashi Shimoyamada, Kawasaki-shi (JP); Hideaki Yasui, Yokohama-shi (JP); Hiroyuki Hasebe, Chigasaki-shi (JP); Koichi Kawamura, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/471,608

(22) Filed: May 26, 2009

Related U.S. Application Data
(63) Continuation of application No. PCT/JP2007/072461, filed on Nov. 20, 2007.

(30) Foreign Application Priority Data
Nov. 27, 2006 (JP) 2006-319125

(51) Int. Cl. G05B 24/00

(52) U.S. Cl. 323/318

(57) ABSTRACT

An electronic device is provided with an electronic device main unit, a power supply unit which has a power generator having a fuel cell unit, and supplies electric power to the main unit, and a switching unit which is connected between the main unit and the power supply unit, and controls turning on and off of the electric power supplied from the power generator to the main unit. The electronic device is provided with a power supply control signal detection unit to detect an external power supply control signal, and a control unit to control turning on and off of the power supply with the switching unit by detection of the power supply control signal with the power supply control signal detection unit.

### CROSS-REFERENCE TO RELATED APPLICATIONS

This is a Continuation Application of PCT Application No. PCT/JP2007/072461, filed Nov. 20, 2007, which was published under PCT Article 21(2) in Japanese.

This application is based upon and claims the benefit of priority from prior Japanese Patent Application No. 2006-319125, filed Nov. 27, 2006, the entire contents of which are incorporated herein by reference.

### BACKGROUND OF THE INVENTION

1. Field of the Invention

The present invention relates to an electronic device using a fuel cell as a power supply.

2. Description of the Related Art

Electronic devices such as a cellular phone and portable information terminal (PDA: Personal Digital Assistants) have been remarkably miniaturized. As an electronic device is miniaturized, a fuel cell is used as a power supply. A fuel cell can generate electric power from fuel and oxidant, and continue generation of electric power simply by replacing fuel. Therefore, a fuel cell is very useful as a power supply of a miniature electronic device if the size can be reduced.

Recently, a direct methanol fuel cell (DMFC) receives attention as a fuel cell. A DMFC is formed by inserting an electrolyte film between an anode and a cathode. The anode and cathode are composed of a power collector and a catalyst layer. Methanol-water solution is supplied to an anode as fuel, and a proton is generated by catalytic reaction. Air is supplied to a cathode (air electrode) through an air inlet. In a cathode, a proton passing through an electrolyte film reacts with oxygen included in the supplied air on a catalyst, and generates electric power. A DMFC uses methanol with a high energy density as fuel, directly takes out electricity on an electrode catalyst, needs no reformulation, and is easier to handle than hydrogen gas. Therefore, a DMFC can be miniaturized, and is much expected as a power supply of a portable electronic device.

An example of such a fuel cell is disclosed in Jpn. Pat. Appln. KOKAI Publication No. 2000-106201. An example of a fuel cell system capable of supplying electric power to an electronic device is disclosed in International Publication No. WO2005/043664.

Use of a cellular phone, one of such electronic devices, is prohibited at locations where an electronic device can be carried in and out, for example in an airplane and a concert hall. In such public places, a warning may be announced to turn off a power supply of such a device.

A conventional cellular phone is designed to turn off the power by a user's will, and is likely to forget to turn off the power. A use of a cellular phone turns off the power supply only after the warning is announced. Sometimes, a user is unaware of the announcement, and is warned in an airplane, or a call tone of a cellular phone may ring during performance in a concert hall.

When a power supply of an electronic device is turned off, fuel is steadily supplied in a fuel cell used as a power supply and electric power is continuously generated, even if a load side does not work at all. Further, so-called a crossover phenomenon occurs and methanol fuel leaks from an anode side to a cathode side in a fuel cell, fuel is steadily supplied and wasted even if a power supply of an electronic device is turned off, causing a problem of decreased fuel consumption efficiency. Further, the life of a fuel cell is reduced by aging degradation caused by chemical reaction accompanying with a crossover phenomenon.

### BRIEF SUMMARY OF THE INVENTION

An object of the present invention is to provide an electronic device using a fuel cell as a power supply controllable by an external instruction, and an electronic device control system which can control an electronic device using a fuel cell as a power supply controllable by an external instruction at locations where an electronic device can be carried in and out.

According to an aspect of the invention, there is provided an electronic device comprising:

an electronic device main unit;

a power supply unit which has a power generator having a fuel cell unit, and supplies electric power to the electronic device main unit;

a switching unit which is connected between the electronic device main unit and the power supply unit, and controls turning on and off of electric power supplied from the power generator to the electronic device main unit;

a power supply control signal detection unit which detects an external power supply control signal; and

a control unit which controls turning on and off of the electric power supply with the switching unit by detection of the power supply control signal with the power supply control signal detection unit.

According to an aspect of the invention, there is provided the electronic device described above, wherein the control unit controls turning off of the switching unit to interrupt electric power supplied from the power generator to the electronic device main unit by detection of the power supply control signal with the power supply signal detection unit.

According to an aspect of the invention, there is provided the electronic device described above, wherein the control unit controls turning on of the switching unit so as to supply electric power to the electronic device main unit by detection of the power supply control signal with the power supply signal detection unit.

According to an aspect of the invention, there is provided described above electronic device described above, wherein the control unit controls turning off of the switching unit to interrupt electric power supplied to the electronic device main unit by first detection of a power supply control signal with the power supply signal detection unit, and controls the switching unit to supply electric power to the electronic device main unit by the next detection of a power supply control signal with the power supply signal detection unit.

According to an aspect of the invention, there is provided the electronic device described above, wherein the power supply control signal detection unit has a receiver to receive external radio waves, and detects the power supply control signal from a radio signal received with the receiver.

According to an aspect of the invention, there is provided the electronic device described above, wherein the control unit is configured to stop supply of one of fuel and air to the fuel cell unit by detecting the power supply control signal.

According to an aspect of the invention, there is provided the electronic device control system described above which has a specific carrying in/out area where the electronic device is carried in and out, and has a transmitter which externally transmits a power supply control signal to the electronic device carried in and out from the carrying in/out area.

According to an aspect of the invention, there is provided the electronic device control system described above, wherein the transmitter is provided at a place where the electronic device is carried in and out from the carrying in/out area.

### BRIEF DESCRIPTION OF THE SEVERAL VIEWS OF THE DRAWING

FIG. 1 is a schematic block diagram showing a configuration of an electronic device according to a first embodiment of the invention;

FIG. 2 is a schematic block diagram showing a configuration of a fuel cell system incorporated in the electronic device shown in FIG. 1; and

FIG. 3 is a schematic block diagram showing a configuration of a fuel cell system incorporated in the electronic device shown in FIG. 1.

### DETAILED DESCRIPTION OF THE INVENTION

An electronic device according to embodiments of the invention will be explained hereinafter with reference to the accompanying drawings.

### First Embodiment

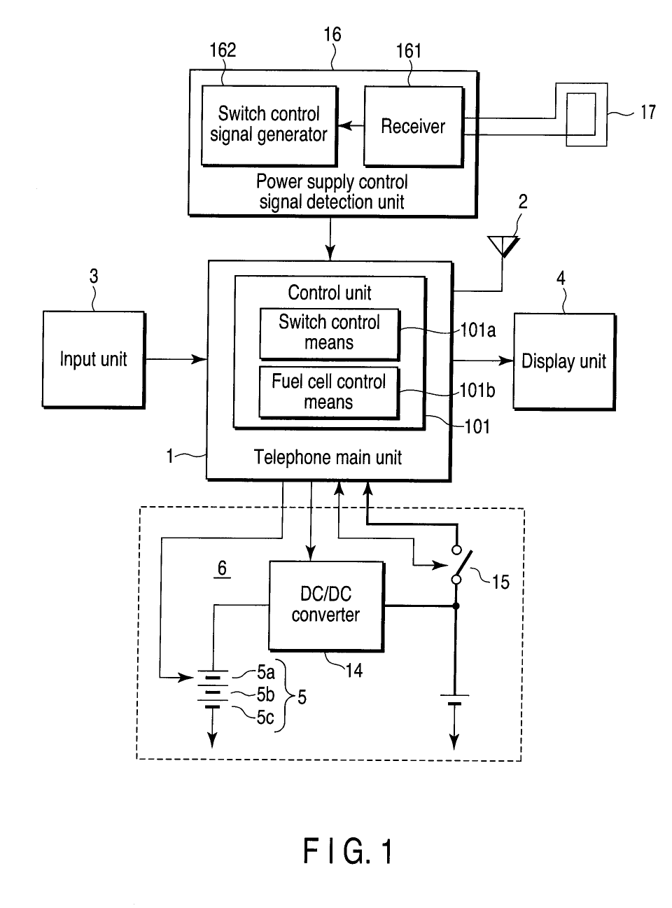

FIG. 1 shows a schematic configuration of an electronic device according to a first embodiment of the invention. In FIG. 1, a cellular phone is shown as an example of an electronic device.

In FIG. 1, a reference number 1 denotes a telephone main unit as an electronic device main unit. A telephone main unit 1 is configured to transmit and receive radio waves of frequencies corresponding to a specified channel, in which an audio signal input from a microphone (not shown) is converted to a high frequency signal, and is output from an antenna 2, and a high frequency signal input to the antenna 2 is converted to an audio signal, and is output from a speaker (not shown). The telephone main unit 1 is connected to an input unit 3 and a display unit 4. The input unit 3 has push-button switches. Operation signals from the push-button switches are input to the telephone main unit 1, and the telephone main unit is operated. The display unit 4 includes a display module such as a liquid crystal display to display various information. The telephone main unit 1 has a control unit 101 as a part to control the telephone main unit 1. The control unit 101 controls the whole telephone main unit 1, and has a switch controller 101a and a fuel cell controller 101b. The switch controller 101a forcibly turns off a power switch 15 by a switch control signal from a power supply control signal detection unit 16 described later. The fuel cell controller 101b controls opening/closing of a valve 13 described later. The fuel cell controller closes the valve 13 and stops electric power generation of a DMFC unit 5 by a switch control signal from the power supply control signal detection unit 16, and opens the valve 13 and restarts electric power generation of the DMFC unit 5 by manual turning on of the power switch 15. The operations of the switch controller 101a and fuel cell controller 101b will be described in detail later.

The telephone main unit 1 has a fuel cell system 10 as a power supply in a power supply compartment (not shown). FIG. 3 shows a configuration of the fuel cell system 10, which is provided with a DMFC unit 5 as a fuel cell unit, a control unit 6, an auxiliary power supply 7, a liquid fuel tank 8, and an output terminal 9. The DMFC unit 5 comprises power generating cells 5a, 5b and 5c. Each of the power generating cells 5a, 5b and 5c has a membrane electrode assembly (MEA), which includes a cathode comprising a cathode catalysis layer and a cathode gas diffusion layer, an anode comprising an anode catalysis layer and an anode gas diffusion layer, and a proton conductive electrolyte layer formed between the cathode catalysis layer and anode catalysis layer. The anode is supplied with methanol-water solution as fuel, and generates a proton by catalytic reaction. The cathode (air electrode) is supplied with air through an air-intake. In the cathode, a proton passing through the electrolyte film reacts with the oxygen included in the supplied air on the catalyst, and generates electric power. The DMFC unit 5 is of a passive type, which supplies fuel and air by utilizing convection or concentration gradient.

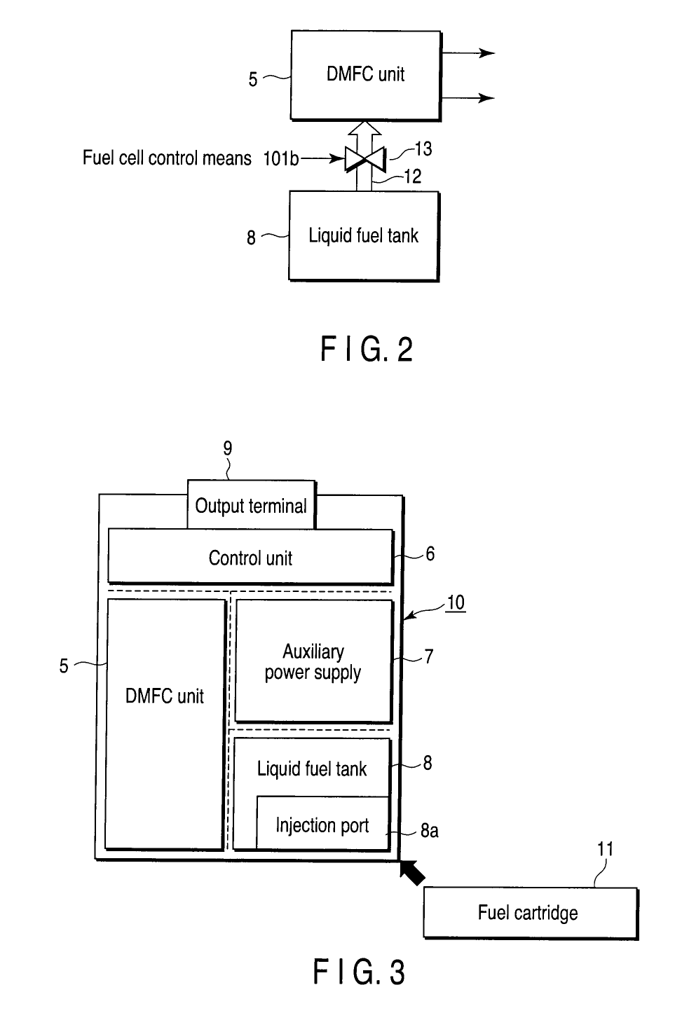

The liquid fuel tank 8 is filled with pure methanol or methanol-water solution. Further, as shown in FIG. 2, the liquid fuel tank 8 is connected to the DMFC unit 5 through a fuel supply path, and the fuel of the liquid fuel tank 8 is supplied to the DMFC unit 5 through the fuel supply path 12. The fuel supply path 12 is provided with a valve 13. The valve 13 is opened and closed by instructions from the fuel cell controller 101b, and supplies or blocks fuel to the DMFC unit 5.

The liquid fuel tank 8 has an injection port 8a. A fuel cartridge 11 is removably fixed to the injection port 8a, and is used to infuse fuel into the liquid fuel tank 8.

Liquid fuel of the liquid fuel tank 8 is not limited to methanol. Ethanol fuel such as ethanol-water solution and pure ethanol, propanol fuel such as propanol-water solution and pure propanol, glycol fuel such as glycol-water solution and pure glycol, dimethyl ether, formic acid or other liquid fuel may be used. Anyway, liquid fuel suitable for a fuel cell is used.

As seen from FIG. 1, the control unit 6 is provided with a control circuit.

In this case, the DMFC unit 5 has power generating cells 5a, 5b and 5c, and generates predetermined output voltage by connecting the power generating cells 5a, 5b and 5c in series. The DMFC unit 5 is connected to a booster DC-DC converter 14 as a part to adjust the output voltage. The DC-DC converter 14 constitutes a power generator, together with the DMFC unit 5. The DC-DC converter 14 has a switching unit (not shown), and an energy storing element to store energy (not shown), which store and discharge the electric energy generated by the DMFC unit 5, and boosts the relatively low output voltage of the DMFC unit 5 to a sufficient voltage level, and supplies the boosted power to the telephone main unit 1 through the output terminal 9.

Here, a standard booster DC-DC converter 14 is used. Any other circuit mode acting as a booster may be used.

The auxiliary power supply 7 is connected to the output terminal of the DC-DC converter 14. The auxiliary power supply 7 is chargeable by the output of the DC-DC converter 14, supplies an electric current for a momentary load change in the telephone main unit 1, and is used as a driving power supply of the telephone main unit 1 when the DNFC unit 5 fails to generate electric power. The auxiliary power supply 7 uses a chargeable/dischargeable secondary cell (e.g., a lithium ion rechargeable battery (LIB) or an electric double-layer capacitor).

The power switch 15 as a switching unit is connected between the output terminal of the DC-DC converter 14, the connection point of the auxiliary power supply 7, and the telephone main unit 1. The power switch 15 is forcibly turned off (off controlled) by the switch controller 101a, and instructs the fuel cell controller 101b to restart electric power generation of the DMFC unit 5 of the fuel cell system 10 by manual turning on by a user of the device.

A reference number 16 denotes a power supply control signal detection unit as a detector to detect a power control signal. The power supply control signal detection unit 16 has a receiver 161, and a switch control signal generator 162. An antenna coil 17 is connected to the receiver 161, forming a receiving unit. The antenna coil 17 is of a type provided inside a not-shown case of the telephone main unit 1, and receives radio waves from a not-shown transmitter installed in places where an electronic device is carried in and out, for example at the entrance of a concert hall. In this case, a not-shown transmitter emits radio waves of the strength enough to reach only a person carrying the device when the person walks through the entrance of a concert hall, for example.

The receiver 161 detects the radio waves received by the antenna coil 161. The switch control signal generator 162 converts a signal detected by the receiver 161 into a direct-current (DC) power, and generates a switch control signal as a power control signal by the DC power. The switch control signal is applied to the control unit 101. The switch controller 101a forcibly turns off the power switch 15, and the fuel cell controller 101b closes the valve 13, blocks fuel supply to the DMFC unit 5, and stops electric power generation of the DMFC unit 5.

Next, an explanation will be given of the functions of the electronic device configured as described above according to an embodiment of the invention.

It is assumed that the valve 13 of the fuel cell system 10 is closed, fuel is supplied from the liquid fuel tank 8 to the DMFC unit 5, which is set to the state of generating electric power, and the power switch 15 is turned on.

In this state, the output of the DMFC unit 5 is boosted by the DC-DC converter 14, the telephone main unit 1 is supplied with electric power, and the auxiliary power supply 7 is charged by the output of the DC-DC converter 14. The telephone main unit 1 is enabled to make a call and e-mail by using the power supplied from the DC-DC converter 14 as a power supply.

The power supply control signal detection unit 16 monitors the input from the antenna coil 17. It is assumed that a user of the device walks through the entrance of a concert hall, for example, and the antenna coil 17 receives radio waves from a not-shown transmitter installed at that place. In the power supply control signal detection unit 16, the receiver 161 detects the wave received by the antenna coil 17, and outputs the detected signal to the switch control signal generator 162. The switch control signal generator 162 converts the signal detected by the receiver 161 into a direct-current (DC) power, and generates a switch control signal by the DC power. The switch control signal of the switch control signal generator 162 is sent to the control unit 101.

The control unit 101 receives the switch control signal. The switch controller 101a forcibly turns off the power switch 15, and instructs the fuel cell controller 101b to close the valve 13. Thereby, the power supply from the DC-DC converter 14 to the telephone main unit 1 is interrupted, and the telephone main unit 1 is set to the power-off state disabling a call and e-mail. Further, as the valve 13 is closed, and the fuel supply from the liquid fuel tank 8 to the DMFC unit 5 through the fuel supply path 12 is interrupted, electric power generation of the DMFC unit 5 is forcibly stopped.

Thereafter, when the power switch 15 is manually turned on by the user of the device, the auxiliary power supply 7 is connected as a power supply of the telephone main unit 1, and the fuel cell controller 101b of the control unit 101 is instructed to restart the electric power generation of the DMFC unit 5. The fuel cell controller 101b instructs to open the valve 13. As the value 13 is opened, fuel is supplied from the liquid fuel tank 8 to the DMFC unit 5 through the fuel supply path 12, and the DMFC unit 5 restarts generation of power. The output of the DMFC unit 5 is boosted by the DC-DC converter 14, and supplied to the telephone main unit 1. The telephone main unit 1 is switched to the state enabling a call and e-mail.

Therefore, as explained above, when a user of the device walks through the entrance of a concert hall, for example, the power switch 15 is forcibly turned off, power supply to the telephone main unit 1 is stopped, and the telephone main unit 1 is set to the power-off state disabling a call and e-mail. This surely prevents failure to turn off the device power can be certainly prevented when entering a concert hall, and avoids ringing of a call tone during performance.

Besides, simultaneous with forcible turning off of the power switch 15, the valve 13 is closed, fuel supply to the DMFC unit 6 is interrupted, and electric power generation of the DMFC unit 5 is stopped. This surely prevents a crossover phenomenon (leakage of methanol fuel from the anode to the cathode) in the DMFC unit 5. Therefore, even if the telephone main unit 1 is not used for a long time, fuel is not unnecessarily consumed, and fuel consumption efficiency is improved, compared with a conventional case in which fuel is continuously supplied and electric power is continuously generated out output. Further, aging degradation caused by a chemical reaction associated with a crossover phenomenon can be prevented, and the life of the DMFC unit 5 can be increased.

### Second Embodiment

In the first embodiment, the DMFC unit 5 stops generating power immediately after the power switch 15 is forcibly turned off, and the telephone main unit 1 is re-powered when the power switch 15 is manually turned on by a user of the device. In the second embodiment, turning on of the power switch 15 and restart of power supply to the telephone main unit 1 are automated.

In the electric device according to the second embodiment, the switch control signal generator 162 of the power supply control signal detection unit 16 shown in FIG. 1 generates a switch control signal by a signal detected by the receiver 161, stores DC power converted from the detected signal in a not-shown storage, and makes the stored DC power usable as a power supply for the control unit 101. The switch controller 101a of the control unit 101 turns off (off-control) the power switch 15 by a first switch control signal from the power supply control signal detection unit 16, and turns on (on-control) the power switch 15 by the next switch control signal. The fuel cell controller 101b closes the valve 13, and stops electric power generation of the DMFC unit 5 by a first switch control signal from the power supply control signal detection unit 16, and opens the valve 13 and restarts the electric power generation of the DMFC unit by the next switch control signal. A transmitter to output the radio waves received by the antenna coil 17 of the power supply control signal detection unit 16 is provided at the exit in addition to the entrance of a concert hall, for example. When the entrance and exit are common, one transmitter may be used.

Except the above points, the configuration of the electronic device of the second embodiment is the same as the first embodiment.

According to the electronic device of the second embodiment, when a user of the device walks through the entrance of a concert hall and the antenna coil 17 receives radio waves from a not-shown transmitter provided at the entrance, the switch control signal generator 162a generates a switch control as described above. The switch control signal is sent to the control unit 101. The switch controller 101a forcibly turns off the power switch 15, and the fuel cell controller 101b closes the valve 13, interrupts fuel supply to the DMFC unit 5, and stops electric power generation of the DMFC unit 5. Thereby, power supply to the telephone main unit 1 is interrupted, and the telephone main unit 1 is set to the power-off state disabling a call and e-mail.

Thereafter, when a user of the device walks through the exit of a concert hall and radio waves from a transmitter (not-shown) are received with the antenna coil 17, the switch control signal generator 162a generates a switch control signal. In this case, a detection signal that detected the radio waves received by the antenna coil 17 is stored in storage (not shown), and the stored power is supplied as a power supply for the control unit 101.

In this state, the switch controller 101a turns off the power switch 15 by a switch control signal. The fuel cell controller 101b opens the valve 13 by the switch control signal, and restarts the electric power generation of the DMFC unit 5. Thereby, the output of the DMFC unit 5 is boosted by the DC-DC converter 14, and supplied to the telephone main unit 1, and the telephone main unit 1 is switched to the state enabling a call and e-mail.

In the configuration described above, when the user walks through the entrance of a concert hall, it is possible to stop power supply to the telephone main unit 1 and set the power-off state disabling a call and e-mail, when the user walks through the entrance of a concert hall, and to restart power supply to the telephone main unit 1 and set the power-on state enabling a call and e-mail, when the user walks through the exit of a concert hall. Power supply to the telephone main unit 1 is automatically stopped and restarted.

The invention is not limited to the embodiments described herein. The invention may be modified without departing from its essential characteristics. For example, in each of the embodiments described herein, the power switch 15 is turned off by receiving radio waves from a transmitter provided at the entrance of a concert hall, and the DMFC unit 5 stops generation of power, and the power supply to the telephone main unit 1 is interrupted. However, the power switch 15 may be turned on (on-control) by receiving radio waves from a transmitter, and generation of power of the DMFC unit 5 may be restarted. This function is effective for a device used only in a certain area, just like a portable device lent to visitors at event sites.

Further, in the embodiments described herein, a cellular phone is described as an example of an electronic device. The invention is applicable to other small-size electronic devices such as a portable audio equipment.

In the embodiments described herein, a concert hall is taken as an example of application places. The invention is applicable to other places where an electronic device is carried in and out, such as a boarding gate in an airport, or a place around a priority seat in a train.

Further, in the embodiments described herein, the fuel cell controller 101b closes the valve 13 and interrupts fuel supply, and the DMFC unit 5 stops generation of power. Generation of power by the DMFC unit 5 may be stopped by blocking air supply by closing the air inlet of the DMFC unit 5. It is of course possible to combine the methods of blocking fuel supply and air supply.

Further, in the embodiments described herein, by receiving radio waves from a transmitter provided at the entrance of a concert hall, the power switch 15 is turned off, the DMFC unit 5 stops generation of power, and power supply to the telephone main unit 1 is interrupted. Power supply to the telephone main unit 1 may be interrupted only by turning off the power switch 15. In this configuration, the initial object that the power supply is controlled by an external instruction can be achieved.

This configuration is effective for example when the output power from the DC-DC converter 14 connected to the DMFC unit 5 is not directly supplied to the telephone main unit 1, but supplied to the auxiliary power supply 7 chargeable by the output of the DC-DC converter 14 and the output power from the auxiliary power supply 7 is supplied to the telephone main unit 1.

Besides, the above embodiments include inventions in various stages, and various inventions can be extracted by appropriately combining the constituent elements disclosed herein. For example, when some of the constituent elements disclosed in the embodiments are deleted, the configuration with some elements deleted can be extruded as an invention, if the problem described in the problem to be resolved by the invention can be resolved, and the effect described in the effect of the invention can be obtained.

For example, in the above explanation, a passive fuel cell is taken as an example of the DMFC unit 5. The invention is applicable to an active fuel cell, and a semi-passive fuel cell using a pump as a part of fuel supply. Either active or semi-passive fuel cell provides the same function and effect as a passive fuel cell. In a semi-passive fuel cell, fuel supplied from a fuel container to a membrane electrode junction is used for power generative reaction, and circulated thereafter, and is not returned to a fuel container. As fuel is not circulated, a semi-passive fuel cell is different from a conventional active type, and does not compromise miniaturization of a device. Further, a fuel cell uses a pump for supplying fuel, and is different from a conventional pure passive type using internal vaporizing. Thus, a fuel cell is called a semi-passive type as described above. In a semi-passive fuel cell, a pump may be replaced with a fuel block valve, as long as fuel is supplied from a fuel container to a membrane electrode junction. In this case, a fuel block valve is provided to control supply of liquid fuel through a flow path.

As for vapor of liquid fuel supplied to MEA, vapor of all liquid fuel may be supplied. The invention is applicable to the case in which a part of liquid fuel is supplied in a liquid state.

According to the invention, there is provided an electronic device using a fuel cell as a power supply controllable from an external instruction, and an electronic device control system which can control an electronic device using a fuel cell as a power supply controllable from an external instruction at places where an electronic device can be carried in and out.

What is claimed is:

1. An electronic device comprising:
an electronic device main unit;
a power supply unit which has a power generator having a fuel cell unit, and supplies electric power to the electronic device main unit;
a switching unit which is connected between the electronic device main unit and the power supply unit, and controls turning on and off of electric power supplied from the power generator to the electronic device main unit;
a power supply control signal detection unit which detects an external power supply control signal; and
a control unit which controls turning on and off of the electric power supply with the switching unit by detection of the power supply control signal with the power supply control signal detection unit.

2. The electronic device according to claim 1, wherein the control unit controls turning off of the switching unit to interrupt electric power supplied from the power generator to the electronic device main unit by detection of the power supply control signal with the power supply signal detection unit.

3. The electronic device according to claim 1, wherein the control unit controls turning on of the switching unit to supply electric power to the electronic device main unit by detection of the power supply control signal with the power supply signal detection unit.

4. The electronic device according to claim 1, wherein the control unit controls turning off of the switching unit to interrupt electric power supplied to the electronic device main unit by first detection of a power supply control signal with the power supply signal detection unit, and controls turning on of the switching unit to supply electric power to the electronic device main unit by the next detection of a power supply control signal with the power supply signal detection unit.

5. The electronic device according to claim 1, wherein the power supply control signal detection unit has a receiver to receive external radio waves, and detects the power supply control signal from a radio signal received with the receiver.

6. The electronic device according to claim 1, wherein the control unit is configured to stop supply of one of fuel and air to the fuel cell unit by detecting the power supply control signal.

7. An electronic device control system which has a specific carrying in/out area where the electronic device according to claim 1 is carried in and out, and has a transmitter which externally transmits a power supply control signal to the electronic device carried in and out from the carrying in/out area.

8. The electronic device control system according to claim 7, wherein the transmitter is provided at a place where the electronic device is carried in and out from the carrying in/out area.
